(19) United States
(12) Patent Application Publication
(10) Pub. No.: US 2004/0141180 A1
(43) Pub. Date: Jul. 22, 2004

(54) Autocorrelator based on triangle delay line and grating delay line

(76) Inventor: Chaozhi Wan, Arcadia, CA (US)

Correspondence Address: CHAOZHI WAN, 923 CORONADO DRIVE, ARCADIA, CA, 91007, US

(21) Appl. No.: 10/347,710

(22) Filed: Jan. 21, 2003

(51) Int. Cl. G01B 9/02

(52) U.S. Cl. 356/450

(57) ABSTRACT

A triangle delay line (or interferometer) for providing a variable time delay for two laser beam comprises a fixed arm having one mirror and a variable arm having a beam splitter and a mirror mounted on a translation stage for adjusting the time delay. The variable arm has to move at a specific direction which in general is different from the longitude direction of the laser beam. The means to determine the moving direction and to calculate the time delay by moving the translation stage have been provided. A single shot autocorrelator based on the triangle delay line is very compact and easy to use. Also a grating delay line comprising a grating, a retroreflection mirror, and a output steering mirror can provide a variable time delay distributed along the beam cross section up to a nanosecond. A single shot autocorrelator utilizing the grating delay line can measure the laser pulse up to hundreds picosecond.

### BACKGROUND OF THE INVENTION

1. Field of the Invention

The present invention generally relates to the field of autocorrelator to characterize laser pulses. More particularly, the present invention relates to autocorrelator devices in pulsed laser apparatus utilizing the triangle delay line (or triangle interferometer) and the grating delay line.

2. Description of the Prior Art

An optical time delay line device (simply delay line) is a necessary part in many devices such as autocorrelators, interferometers, and wavemeters. A conventional optical time delay line has a fixed arm with a fixed time delay and a variable arm with variable time delay in which retroreflection mirrors move along the longitude direction of the laser beam to change the path length of the laser beam traveling through the delay line. In pulsed laser apparatus like single shot autocorrelator and frequency-resolved optical gating device, an conventional optical time delay line is most commonly used (Trebino et.al., U.S. Pat. No. 5,530,544, June 1996). However, the conventional delay lines are complicated, bulky, and costly. The difficulty in alignment makes these devices inconvenient.

Some more complicated optical delay lines have been invented such as having a helicoids reflecting mirror (Wang et.al., U.S. Pat. No. 5,907,423, May 1999) and having a grating with the ability to scan the time delay (Tearney et.al., U.S. Pat. No. 6,282,011 B1, August 2001). Other time delay devices are a tunable time plate (Wan, U.S. Pat. No. 5,852,620, December 1998) and a Mach-Zehnder interferometer type (Schaefer et.al., U.S. Pat. No. 5,068,525, November 1991). However, these delay line devices are not suitable for a single shot autocorrelator since they are too complicated or have to scan the time delay when measuring laser pulses.

Single shot autocorrelator devices can also utilize a Fresnel biprism delay line. However, only a fixed time delay and a fixed angle between two laser beams are available. Also a dispersing component of Fresnel biprism is not desirable in many cases. Therefore, it is desirable to have new delay line devices, which can overcome the drawbacks of previous delay line devices and provide new features.

Also the previous single shot autocorrelators are limited to measure the laser pulse about 1 picosecond or less. With using a grating previous single shot autocorrelator can measure the laser pulse to several picoseconds. However, the prior art of the grating delay line comprising a single grating has several drawbacks: (1) the small time delay range, (2) the dependence of the time delay on the laser beam size, and (3) the fixed time delay. Therefore, a new grating delay line device is desirable to have a longer and variable time delay without the drawbacks of previous grating delay line.

### SUMMARY OF THE INVENTION

The present invention is the triangle delay line (or interferometer) and the grating delay line. The single shot autocorrelators based on the triangle delay line and the grating delay is very compact and easy to use and can measure the laser pulse duration from femtoseconds to hundreds picosecond.

It is an object of the present invention to provide a new delay line device to be more compact and simpler. In the preferred embodiments of the present invention, the triangle delay line device utilizes only a beam splitter and two mirrors. The fixed arm of the triangle delay line is a flat mirror or a grating. The variable arm of the triangle delay line comprises a beam splitter and a mirror. The variable arm is mounted on a translation stage for adjusting the time delay. The present invention triangle optical delay lines have two major differences from conventional optical delay line. First, the variable arm of the triangle delay line moves at a direction in general different from the longitude direction of laser beam as in conventional delay lines. Second, the beam splitter is part of the variable arm. The triangle delay line includes a backward arrangement and a forward arrangement. The moving direction of the variable arm and the time delay can be determined separately for the backward triangle delay line and the forward triangle delay line. In the alternative embodiments of the present invention, the triangle delay line device is utilized in single shot autocorrelators.

The object of the grating delay line is to extend the time delay range up to nanosecond level for single shot laser devices such as autocorrelators and time resolved optical gate devices. In the preferred embodiment of the present invention, the grating delay line comprises a grating, a retroreflection mirror, and an output steering mirror. The grating delay line can generate a time delay distributed along the laser cross section up to nanosecond by adjusting the angle of the grating and the retroreflection mirror. The maximum time delay generated by the grating delay line is no longer limited by the laser beam size instead is limited by the grating size. In one of the alternative embodiments of the present invention, the grating delay line is utilized in single shot autocorrelators to have the extended time range up to nanosecond.

The laser pulse devices that utilizing the present invention triangle delay line such as the single shot autocorrelators disclosed herein below, are more compact, easier to use, and less expensive than those utilizing the conventional delay line devices. With the triangle delay line, a single shot autocorrelator can measure the pulse duration from femtoseconds to picoseconds. With both the triangle delay line and the grating delay line a single shot autocorrelator can measure the pulse duration up to hundreds picoseconds.

### BRIEF DESCRIPTION OF THE DRAWINGS

Referring particularly to the drawings of the purpose of illustration only and not limitation, there is illustrated:

FIG. 1 is an illustrative diagram showing the present invention triangle delay line (interferometer) comprising a fix arm having one mirror and a variable arm having a beam splitter and a mirror mounted on a translation stage. The backward triangle delay line has the input beam and the output beam at the same side of the beam splitter.

FIG. 2 is an illustrative diagram showing an alternative of the present invention triangle delay line (interferometer) comprising a fix arm having one mirror and a variable arm having a beam splitter and a mirror mounted on a translation stage. The forward triangle delay line has the input beam and the output beam at the different side of the beam splitter.

FIG. 3 is an illustrative diagram showing the basic principle and arrangement of the present invention triangle delay line.

FIG. 4 is an illustrative diagram showing the basic principle and arrangement of the alternative of the present invention triangle delay line.

FIG. 5 is an illustrative diagram of a single shot autocorrelator device utilizing the present invention triangle delay line.

FIG. 6 is an illustrative diagram of an alternative single shot autocorrelator device utilizing the alternative of the present invention triangle optical delay line.

FIG. 7 is an illustrative diagram of an autocorrelator device utilizing the present invention triangle optical delay line for weaker laser energy pulses.

FIG. 8 is an illustrative diagram of an alternative autocorrelator device utilizing the present invention triangle optical delay line for weaker laser energy pulses.

FIG. 9 is an illustrative diagram showing (a) the present invention grating delay line with variable time delay and (b) the prior art of grating delay line with fixed time delay.

FIG. 10 is an illustrative diagram of a single shot autocorrelator device utilizing the present invention grating delay line.

### DETAILED DESCRIPTION OF THE INVENTION

Although specific embodiments of the present invention will now be described with reference to the drawings, it should be understood that such embodiments are by way example only merely illustrative of but a small number of the many possible specific embodiments which can represent applications of the present invention. Various changes and modifications obvious to one skilled in the art the present invention pertains are deemed to be within the spirit, scope and contemplation of the present invention as further defined in appended claims.

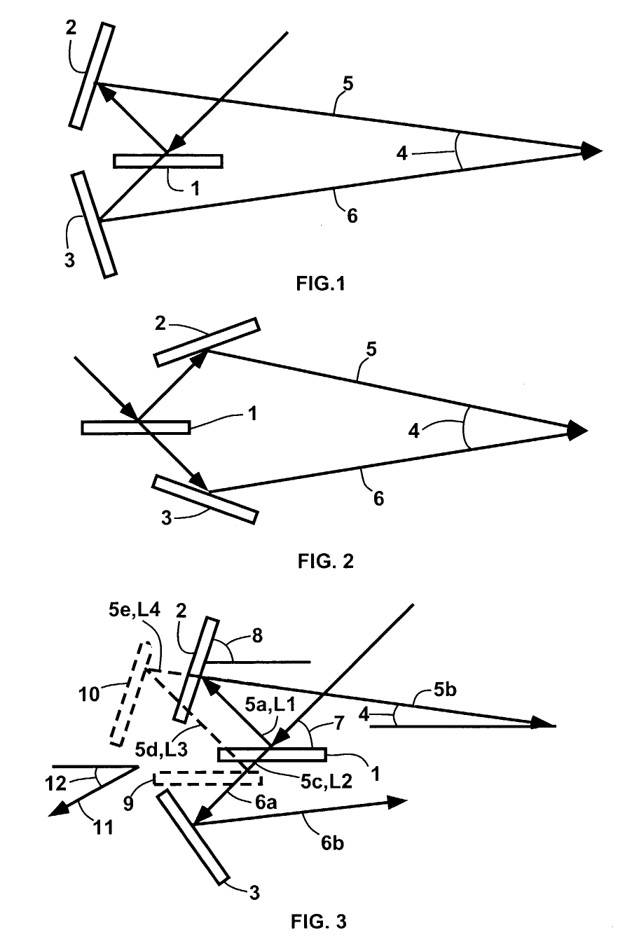

Referring to FIG. 1, there is shown one of the preferred embodiments of the present invention triangle delay line (interferometer). There is shown the backward arrangement of the triangle delay line device. The triangle delay line device utilizes a beam splitter 1 and a mirror 2 to be mounted on a translation stage to form the variable arm of the delay line for changing the path length of the variable arm of the laser beams. The beam splitter 1 can be a partial reflection mirror, a polarization beam splitter plate, or a cubic prism beam splitter. The mirror 3 forms the fixed arm of the triangle delay line. The fixed arm 3 of the triangle delay line can be a mirror or a grating. The two laser beams from the variable arm 5 and from the fixed arm 6 meet together at an angle 4. The time delay between the two beams is variable by moving the translation stage of the variable arm. At the cross section of the two beams the line interference pattern will be formed within the laser beam size profile. The space between two interference lines is determined by the phase difference or time delay between the two beams at the two beam cross section. The phase difference in turn is determined by the cross angle 4 of the two beams and wavelength.

Referring to FIG. 2, there is shown a preferred alternative embodiments of the present invention triangle delay line (interferometer). There is shown the forward arrangement. The delay line also comprises the variable arm formed by the beam splitter 1 and the mirror 2 and the fixed arm of the mirror 3. The difference of the triangle delay line is the forward direction of the input beam.

The present invention triangle optical delay lines shown here have two major differences from conventional optical delay line. First, the variable arm of the triangle delay line moves, in general, in a direction different from, as well same as, the longitude direction of laser beam as in conventional delay lines. Second, the beam splitter is part of the variable arm.

It is required for a delay line to generate a time delay without inducing space-displacement of the laser beams while moving its variable arm. The requirement demands the special arrangements of the triangle delay line. Referring to FIG. 3, there is shown the basic principle and the arrangement of the present invention triangle delay line device. A laser beam when it reaches the beam splitter 1 at an angle 7 (θ₁) will be separated as two beams, the reflected 5 and transmitted 6 beams. The reflected beam 5a is then reflected by the mirror 2 with an angle 8 (θ₂) with respect to the beam splitter. The beam splitter 1 and the mirror 2 mounted on a translation stage can move along a direction 11 determined by the angle 12 (θ₃) and will locate at the new position 9 and 10, respectively. The reflected beam 5 then has an increased path length (5c, 5d, and 5e) while the transmitted beam 2 keeps the same path length. The key to the requirement of the zero displacement of laser beams is the right moving direction 12 of the translation stage of the variable arm, which can be determined by the angle 7 (θ₁) of the input beam and the angle 8 (θ₂) of the mirror 2 with respect to the beam splitter 1, respectively. Though the calculation is complicated we obtained a simple equation to calculate the angle 12 (θ₃) using the geometry shown in FIG. 3:

θ₃=θ₁+θ₂−90°. [1]

The path length change by moving the translation stage L distance is equal to the summation of all the distance change,

DL=L2+L3+L4−L1. [2]

The time delay due to the path length change DL then is obtained by the following equation:

TD=L·(10/3)·(1/sin θ₁)·{2 sin θ₃·sin² θ₂+sin(2θ₂)cos θ₃}, [3]

with the unit of picosecond if L in millimeter.

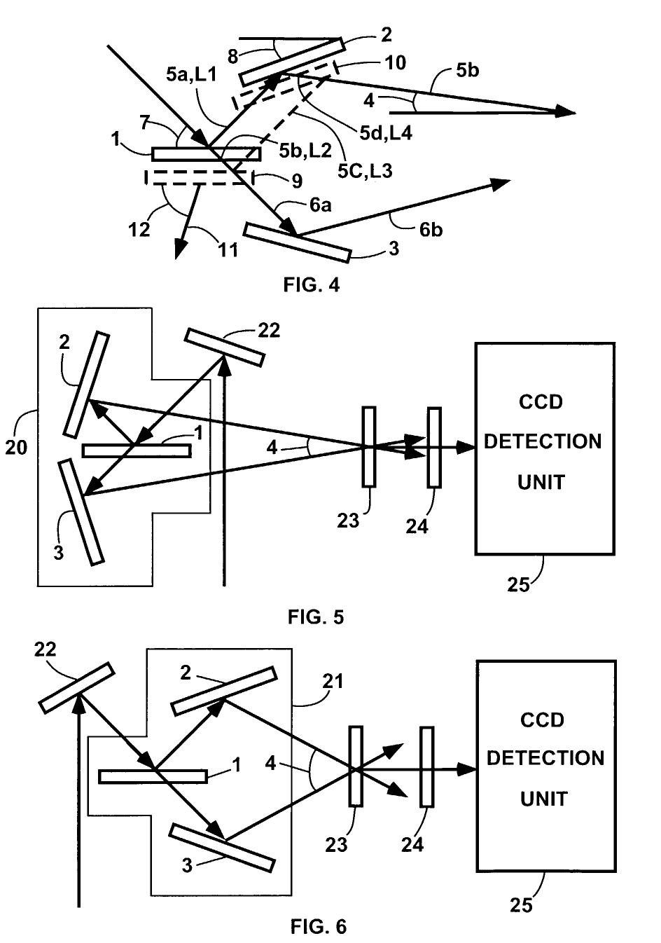

Referring to FIG. 4, there is shown the basic principle and arrangement of the alternative of the present invention triangle delay line. The delay line shows a forward beam arrangement. The input beam coming from left side at an angle 7 (θ₁) with respect to the beam splitter 1 is separated into two beams by the beam splitter 1. Then the reflected beam 5a is reflected towards the right side of the diagram by the mirror 2 with an angle 8 (θ₂) with respect to the beam splitter 1. The beam splitter 1 and the mirror 2 located on a translation stage form the variable arm of the triangle delay line. The time delay is variable by moving the translation stage in the direction 11 determined by the angle 12 (θ₃) with respect to the beam splitter 1. Similarly we obtained the angle 12 (θ₃) in this case as

θ₃=90°−θ₁+θ₂, (4)

We also obtained the time delay by moving the L distance of the translation stage as

TD=L·(10/3)·{2 sin² θ₁+sin(2θ₂)cos(2θ₁−2θ₂)−sin(2θ₁)/sin(2θ₁−2θ₂)}tm (5)

with the unit of picosecond if L in millimeter.

Further preferred embodiments of the present invention triangle delay line will be described as follows, based on the basic principles of the present invention as described above and as illustrated in FIGS. 1-4. These embodiments will be described as they are in FIGS. 5 through 10. However, in the following description, the same features or functions will not be described repeatedly. Rather, the focus will be on the differences of these further embodiments from the basic arrangement.

The various embodiments of the present invention triangle delay line device can be utilized in many laser devices such as autocorrelators and interferometers, to replace the conventional delay line devices. The present invention triangle delay line devices make the laser devices more efficient, more compact, easier to use, and less expensive. The following descriptions are merely examples of the many laser devices, which can utilize the present invention triangle delay line.

Referring to FIG. 5, there is shown an illustrative diagram of a single shot autocorrelator utilized the present invention triangle delay line (interferometer). The single shot autocorrelator comprises the triangle delay line with the backward arrangement 20 and the detection components. A laser beam is delivered by the input mirror 22 to send the laser beam into the triangle delay line 20. The laser beam is separated into two beams by the triangle delay line 20 and they meet together at the position of the second harmonic generation (SHG) crystal 23 to generate the autocorrelation (SHG) signal. The SHG signal is then detected by the CCD multichannel detection unit 25 after passing through the optical filter 24. The time delay of the autocorrelation (SHG) signal on each pixel of the CCD is determined by the cross angle 4 and can be calibrated by moving the variable arm of the triangle delay line 20 and using the time delay calculated from the equation (3).

Referring to FIG. 6, there is shown an illustrative diagram of an alternate single shot autocorrelator utilized the present invention triangle delay line with forward arrangement 21. The autocorrelator comprises the forward triangle delay line 21 and the detection components. A laser beam is reflected by the input mirror 22 to send the laser beam into the triangle delay line 21. The laser beam is separated into two beams by the triangle delay line and they meet together at the position of the second harmonic generation (SHG) crystal 23. The generated autocorrelation signal (SHG signal) is then detected by the CCD multichannel detection unit 25 after passing through the optical filter 24. The time delay of the autocorrelation signal on each pixel of the CCD is determined by the cross angle 4 and can be calibrated by moving the variable arm of the triangle delay line 21 and using the time delay calculated from the equation (5).

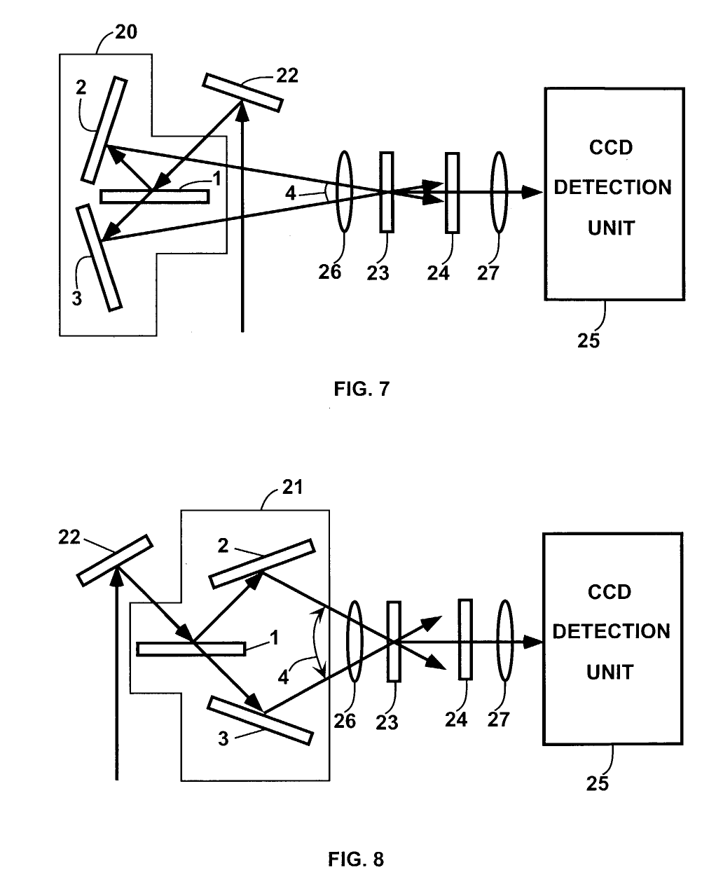

Referring to FIG. 7, there is shown an illustrative diagram of an alternate single shot autocorrelator for weaker energy pulses utilized the present invention triangle delay line of the backward arrangement. The differences of this single shot autocorrelator from the one shown in FIG. 5 are the two cylindrical lenses 26 and 27 being added into the autocorrelator. The first cylindrical lens 26 focuses the laser beams at the position of the SHG crystal 23 to increase the intensity of the SHG signal and the second cylindrical collimates and focuses the SHG signal to the CCD multichannel detection unit 25. The addition of the cylindrical lenses will increase the sensitivity of the autocorrelator for weaker energy pulses.

Referring to FIG. 8, there is shown an illustrative diagram of an alternate single shot autocorrelator for weaker energy pulses utilized the present invention triangle optical delay line of the forward arrangement. Similarly, the differences of the single shot autocorrelator from the one shown in FIG. 6 are the two cylindrical lenses 26 and 27 being added into the autocorrelator to compensate the laser pulse having low energy.

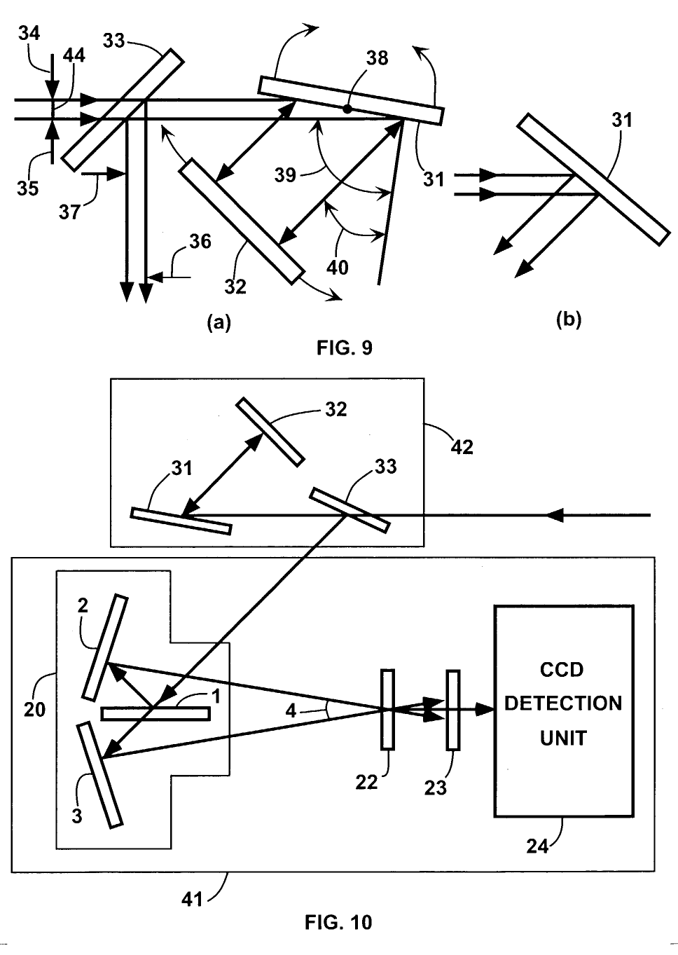

In single shot autocorrelators and single shot frequency resolved optical gate devices (FROG) the time information is recorded by a CCD multichannel detector. The total time range (T) of measurement is a function of the diameter of the laser beams (D) and the crossing angle (φ) of two crossed beams: T=(20/3)·D·sin(φ/2) in the unit of picosecond when D in millimeter. For a beam size 10 mm and a crossing angle 8°, the time range is about 4.6 picosecond. To measure laser pulse width from a few picosecond to hundreds picosecond a much larger time range is desired. A simple way of using a grating can extend the time delay to tens picosecond as shown in FIG. 9b. However, the total time range is still limited and depends on the input beam size. To extend the time range hundreds times to a nanosecond level without the drawbacks of the simple grating method we invented a grating delay line. The time range of the grating delay line is variable and is no longer limited by the laser beam size.

Referring to FIG. 9a, there is shown one of the preferred embodiments of the present invention grating delay line. The grating delay line comprises a grating 31, a retroreflecting mirror 32, and an output steering mirror 33. A laser beam having a diameter 44 (D) with an incident angle 39 (θᵢ) is diffracted by the grating 31 with a diffraction angle 40 (θ_{d}). The diffraction beam is then reflected back to the grating 31 at the same angle by the mirror 32. The retroreflected beam is titled down a little bit by the mirror 32 to reach the output steering mirror 33. The incident angle 39 and the diffraction angle 40 are adjustable by rotating the grating 31 and the mirror 32 around the axis 38, separately. The beam size of the output beam from the steering mirror 33 is the same as that of the input beam. However, a time delay along the laser beam profile has been generated. As shown in FIG. 9a the portion 34 and the portion 35 of the laser beam have the same time delay at the beginning while they have a different time delay indicated by the arrow position 36 and 37, respectively, after going through the grating delay line. The total time delay (T) is a function of the incident angle 39 (θᵢ), the beam size (diameter D), the grating line separation (d), and the laser wavelength (λ):

T=(20/3)·(D/cos(θᵢ))·(λ/d), (6)

with the unit of picosecond when D in millimeter. The factor D/cos(θᵢ) in equation (6) is in fact the projection of the laser beam on the grating and the maximum factor D/cos(θᵢ) depends only on the grating size not on the laser beam size. For a 100 mm grating, for example, the maximum factor D/cos(θᵢ) is 100 mm for a beam with D=5 mm and θᵢ=87° the same as for a beam with D=10 mm and θᵢ=84°. The maximum time delay for a 100 mm grating is 1.3 and 0.67 nanosecond if the λ/d factor is 2 and 1, respectively. Apparently, according to the equation (6) the time delay is variable by adjusting the incident angle 39 (θᵢ) of the grating. The diffraction angle 40 (θ_{d}) is then determined by the grating equation d(sin(θᵢ)+sin(θ_{d}))=λ. Therefore, the retroreflection mirror 32 has to be adjusted accordingly. Another important feature of the present invention grating delay line is that the beam size of the output beam is the same as that of the input beam.

Referring to FIG. 10, there is shown an illustrative diagram of a single shot autocorrelator utilized the present invention grating delay line and triangle delay line. The single shot autocorrelator is the same as that shown in FIG.5 except that the input steering mirror 22 is replaced by the grating delay line 42. A laser beam is first sent to the grating delay line to generated the time delay along the beam cross section. The output beam from the grating delay line is then sent to the single shot autocorrelator 41 to measure the pulse width with the extended time range. Since the detailed descriptions of the grating delay line 42 and the autocorrelator 41 have been given above we will not repeat them again. Similarly, the single shot autocorrelator illustrated in FIGS. 6-8 can have an extended time range up to nanosecond by replacing the input steering mirror 22 with the present invention grating delay line 42. However, we will not repeat these descriptions again.

Defined broadly, the present invention is a triangle delay line (or interferometer) for providing the variable time delay between two laser beams. Also the present invention is a grating delay line for providing the time delay linearly distributed along the cross section of a laser beam. Defined alternatively, the present invention is a single shot autocorrelator utilizing the triangle delay line for measuring the laser pulse duration from femtoseconds to picoseconds and a single shot autocorrelator further utilizing the grating delay line to measure the laser pulse duration from picoseconds to hundreds picoseconds.

Of course the present invention is not intended to be restricted to any particular form or arrangement, or in any specific embodiment disclosed herein, or any specific use, since the same may be modified in various particulars or relations without departing from the spirit or scope of the claimed invention herein above shown and described of which the apparatus shown is intended only for illustration and for disclosure of an operative embodiment and not to show all of the various forms or modification in which the present invention might be embodied or operated.

The present invention has been described in considerable detail in order to comply with the patent laws by providing full public disclosure of at least one of its forms. However, such detailed description is not intended in any way to limit the broad features or principles of the present invention, or the scope of patent monopoly granted.

What is claimed is:

1. A triangle delay line (or interferometer) for providing a time delay between two output laser beams which are separated from one input laser beam or from two input beams with different wavelength, the said triangle delay line comprising:
a. a variable arm mounted on a translation stage to generate a variable time delay;
b. a fixed arm to have fixed time delay;
c. means to determine the angle of the moving direction of the said translation stage;
d. means to determine the change of the time delay of the said variable arm of the said triangle delay line by moving the said translation stage;
e. a backward triangle delay line is defined wherein the said input laser beam and the said output laser beams are in the same side of the said triangle delay line;
f. a forward triangle delay line is defined wherein the said input laser beam and the said output laser beams are in the different side of the said triangle delay line.

2. The triangle delay line as defined in claim 1, wherein the said fixed arm is a mirror, or a grating.

3. The triangle delay line as defined in claim 1, wherein the said variable arm mounted on the said translation stage comprises a beam splitter, which splits an input beam into two beams, and a steering mirror.

4. The variable arm as defined in claim 3, wherein said beam splitter is a partial reflection mirror, or a polarizing plate, or a cube prism beam splitter.

5. A single shot autocorrelator for determining the characteristics of an input laser pulse beam, the said autocorrelator comprising:
a. a steering mirror;
b. a triangle delay line as defined in claim 1 to separate the said input laser pulse beam into two crossed beams with variable time delay;
c. a second harmonic generation (SHG) crystal to generate the autocorrelation (SHG) signal from the said two crossed fundamental laser beams;
d. an optical filter to pass the said SHG signal while to cut off the said two crossed fundament laser beams;
e. a CCD multichannel detection unit to record the said SHG signal.

6. A single shot autocorrelator as defined in claim 5, further comprising at least one focus lens for compensating the said input laser pulse having low pulse energy.

7. A grating delay line to generate a time delay distributed along the cross section of a laser beam, the said grating delay line comprising:
a. a diffraction grating;
b. a retroreflection mirror;
c. an output steering mirror;
d. means to vary the said time delay by adjusting the angle of the said grating and the angle of the said retroreflection mirror.

8. A single shot autocorrelator as defined in claim 5, wherein the said steering mirror is replaced by a grating delay line as defined in claim 7 to extend the time range of the measurement of the said autocorrelator.

9. A single shot autocorrelator as defined in claim 8, further comprising at least one focus lens for compensating the said input laser pulse having low pulse energy.
